(19) United States
(12) Patent Application Publication
(10) Pub. No.: US 2024/0153220 A1
(43) Pub. Date: May 9, 2024

(54) Augmented reality application and method

(71) Applicant: Diesel Holdings, LLC, Carrollton, TX (US)

(72) Inventors: Scott Focke, Argyle, TX (US); Brent Ashton, Dallas, TX (US)

(21) Appl. No.: 18/414,353

(22) Filed: Jan. 16, 2024

Related U.S. Application Data
(63) Continuation-in-part of application No. 17/412,193, filed on Aug. 25, 2021.
(60) Provisional application No. 63/087,837, filed on Oct. 5, 2020.
(60) Provisional application No. 63/070,235, filed on Aug. 25, 2020.

(51) Int. Cl. G06T 19/00; G06Q 30/0241; G06Q 30/0251; G06T 7/73; G06T 11/00; G06V 20/20

(52) U.S. Cl. CPC G06T 19/006; G06Q 30/0267; G06Q 30/0277; G06T 7/74; G06T 11/00; G06V 20/20; G06T 2207/30204

(57) ABSTRACT

An augmented reality (AR) app for execution on a user device is configured to receive an image of at least one real-world object including image data of at least one target image incorporating at least one marker. The mobile app automatically detects a presence of the at least one marker in the image data of the at least one target image, automatically identifies at least one AR experience video in response to the detected at least one marker, automatically access a database to retrieve the at least one AR experience video, and automatically render the at least one AR experience video on the display screen of the user device for viewing by a user, where the at least one AR experience video replaces at least a portion of the at least one target image on the real-world object when viewed on the display screen.

### RELATED APPLICATIONS

This application is a Continuation-In-Part application of U.S. patent application Ser. No. 17/412,193 filed on Aug. 25, 2021, which claims the benefit of U.S. Provisional Application No. 63/070,235 filed on Aug. 25, 2020 and U.S. Provisional Application No. 63/087,837 filed on Oct. 5, 2020, all of which are incorporated herein by reference in their entirety.

### FIELD

The present disclosure relates to the field of augmented reality, and in particular, to an augmented reality (AR) mobile application and method.

### BACKGROUND

Augmented reality (AR) is an interactive experience of a real-world environment where the objects that reside in the real world are enhanced by computer-generated perceptual information across one or more sensor modalities, including visual, auditory, haptic, somatosensory, and olfactory. This AR experience is typically interwoven with the physical world such that it is perceived as an immersive aspect of the real world environment. In this way, augmented reality alters or enhances one's sensory perception to bring aspects of the virtual world into the user's perception of the real-world environment.

### BRIEF DESCRIPTION OF THE DRAWINGS

FIG. 1 shows an example physical flyer 100 that may be used to trigger an augmented reality (AR) experience for a user according to the teachings of the present disclosure;

FIGS. 2-6 show examples of images displayed on a mobile device screen during the augmented reality process according to the teachings of the present disclosure;

FIGS. 7-9 is a flowchart of the augmented reality process according to the teachings of the present disclosure;

FIG. 10 is a simplified block diagram of a computing environment for implementing the augmented reality process according to the teachings of the present disclosure;

FIG. 11 is a simplified block diagram showing some of the available menu and scene selection templates of the AR development toolkit according to the teachings of the present disclosure;

FIGS. 12-17 are examples of screen displays of the menu and functionality templates of the AR development toolkit according to the teachings of the present disclosure;

FIGS. 18-21 is a simplified flowchart showing process flow of the AR development toolkit according to the teachings of the present disclosure;

FIG. 22 is a simplified flowchart of another embodiment of the AR process according to the teachings of the present disclosure;

FIGS. 23 and 24 are a simplified block diagrams showing the operation of two embodiment of the AR experience for a user initiated by a target image according to the teachings of the present disclosure;

FIGS. 25-27A and 27B are simplified diagrams showing examples of the triggering AR experiences from combined multi-target images according to the teachings of the present disclosure;

FIGS. 28-30 are simplified diagrams showing further examples of the triggering AR experiences from combined multi-target images according to the teachings of the present disclosure;

FIGS. 31-33 are simplified diagrams showing examples of the resultant AR experience images initiated by combined multi-target images according to the teachings of the present disclosure; and

FIG. 34 is a simplified block diagram of a mobile device that may operate as a suitable execution platform for the AR mobile app according to the teachings of the present disclosure.

### DETAILED DESCRIPTION

The augmented reality (AR) technology described herein includes the use of a web browser and/or mobile app-based method that uses augmented reality to present information for primarily advertising, marketing, and promotion of goods and services. The augmented reality process described herein presents information and images by displaying them on the screen of a mobile device (or field of view) that shows them overlaid on top of physical real-world 2-D or 3-D objects. Examples of these real-world objects include business cards, playing cards, trading cards, newspaper ads, postcards, posters, signage, painting, drawing, billboards, flyers, product labels, product packaging, package inserts, user manuals, pet ID tags, personal identification cards, company badges, puzzle pieces, clothing tags, apparel, headwear, shoes, and jewelry. Further, to facilitate ease of app development, maintenance and updates, the AR app development toolkit described herein uses a repository of premade systems that can be readily altered to create new applications that results in greatly reduced AR app development time.

As described herein, a variety of mobile devices and input types are supported by the toolkit as means to interact with premade and custom-made content. Two repositories are provided for the toolkit, one built in the Unity Engine, primarily using the C#programming language, and the other built primarily using JavaScript, HTML, and CSS for browser-based applications. The most notable difference in user-experience between applications built with these repositories is that apps created with the Unity version must be installed on the user's mobile device, while the browser version does not, but does require an internet connection to function.

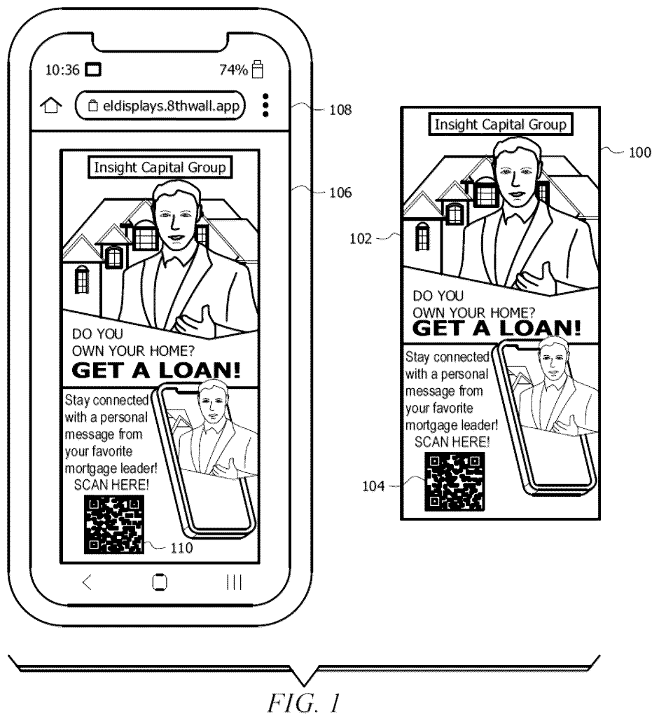

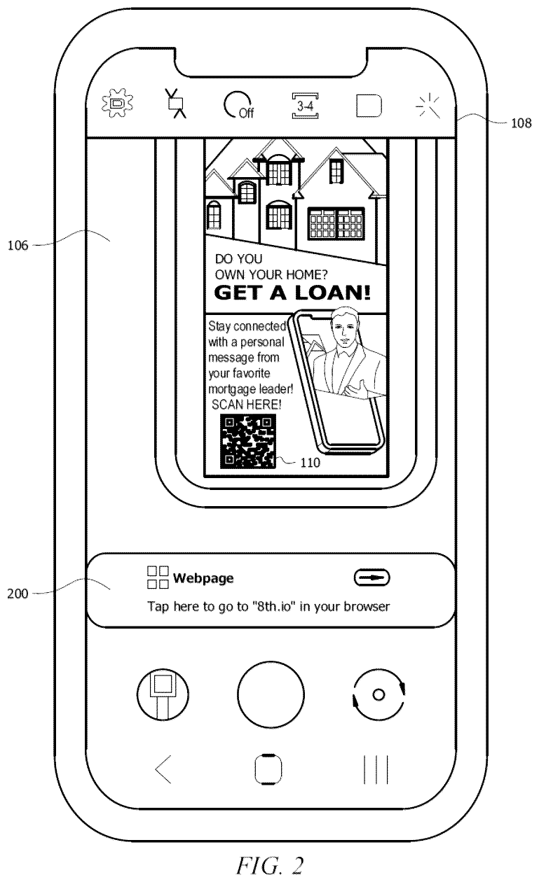

FIG. 1 shows an example physical flyer 100 with a representative graphics or image 102 printed on one or both sides of a 2-D object with at least one defined plane. For this example, the carrier of the target image is an advertising flyer 100 that may be mailed, handed to, or otherwise distributed to a target audience such as potential customers. The graphics printed on the flyer 100 includes a machine-readable code 104, such as a bar code, a QR code, or another suitable machine-readable pattern. Instead of a machine-readable pattern, the sophisticated mobile app may analyze the captured image for recognition of any pre-existing stored image or pattern. The target image may incorporate one or more markers that have been previously designated and stored as an AR experience initiation marker. When viewed through a camera or any suitable imaging device of a mobile device 108, the target image on the flyer 100 is displayed on a screen 106 of the mobile device 108, including an image 110 of the QR code (or recognized marker embedded or incorporated in an image or pattern). The imaging/scanner application executing in the mobile device 108 causes it to display a prompt 200 (FIG. 2) that asks the user if they want to navigate to the linked website using a web browser. Upon receiving the user's input, the web browser executing in the mobile device 108 navigates to the website specified by the QR code. At the specified web page, the user is asked to download and install the AR-enabling mobile application. Upon receiving the user's approval, the AR app is downloaded and execution of the AR application may automatically begin. In an alternate embodiment, the AR app is automatically downloaded to the user's device when the user scans the QR code.

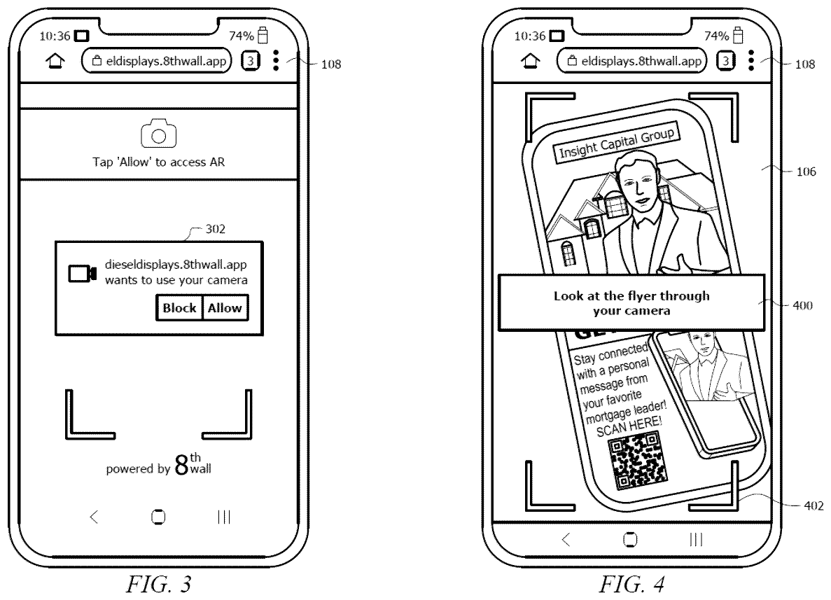

Users opening the AR mobile app for the first time are prompted (302) to allow the browser to access their camera (FIG. 3). In order for the AR app to function, it must be able to access the onboard camera or an imaging device of the mobile device 108. One or more inquiries for user permissions may be displayed on the screen of the mobile device 108 to solicit the required permissions. Pressing “Block” will prevent the AR app from working and instead display instructions for enabling the camera in order to proceed. Pressing “Allow” will enable the device camera and display a prompt 400 to instruct the user to point their device camera at the physical flyer, and to view the target image of the flyer displayed on the screen 106 (FIG. 4).

The AR app executing on the mobile device analyzes the image data from the camera and performs image recognition. Once the AR app recognizes or detects the anticipated target image on the physical flyer 100, a prompt 400 is displayed on the screen, in this example, “Look at the flyer through your camera,” as shown in FIG. 4. Indicators 402, such as brackets shown in FIG. 4, may be displayed on the screen to guide the user to orient the mobile device properly so that the target image of the flyer falls within the area defined by the bracket.

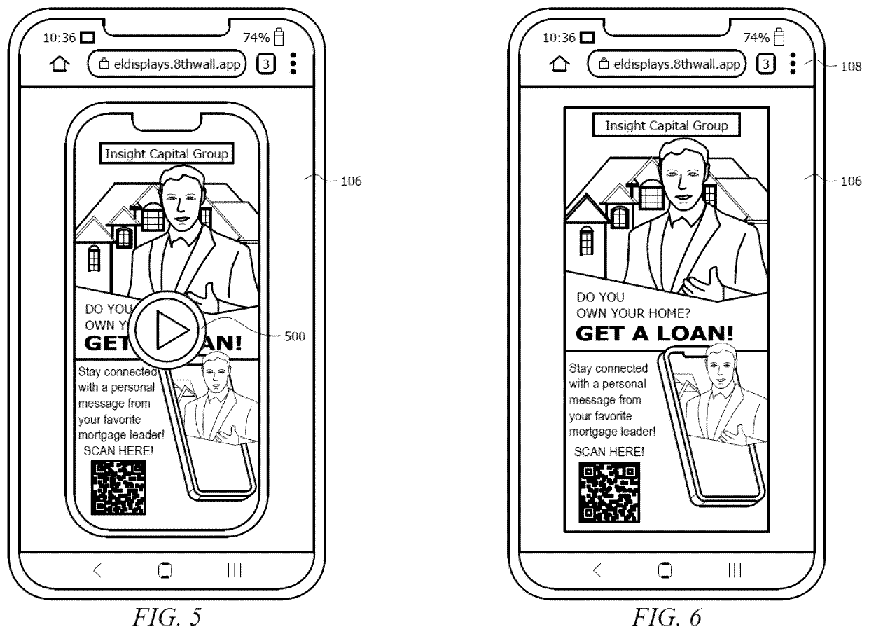

As shown in FIG. 5, once the target image on the flyer is properly oriented and displayed on the user device screen 106, a play button 500 is shown superimposed over the image. Alternatively, the AR app may automatically initiate the AR image sequence as soon as it detects the flyer image is properly oriented on the screen 106. When the user taps this play button 500, a video begins to play and superimpose moving images onto the scene displayed on the screen 106 as if the target image printed on the static flyer 100 has come to life. For example, the static image of the gentleman on the physical flyer, when viewed by the user on the screen of the mobile device, is now animated with motions, gestures, and audio speech (e.g., FIG. 6). Until the video finishes playing, the user is able to pause and play the video by tapping the proper control icons with their finger, toggling the play/pause state. Other suitable controls may be available to the user. As long as the user is pointing the camera of the mobile device at the physical flyer 100, the AR effect is maintained until the AR video ends. The mobile app keeps track of the location of the target image on the display screen so that the AR experience video can be overlaid on top of the target image to enhance the AR experience.

After initial image tracking of the flyer is established, if the device camera loses sight of the tracked flyer, the video object will attach itself to the user's device camera to remain in view. When the video finishes playing, a brief delay, such as a one second delay, elapses. After this delay, the user may be automatically redirected to a website that provides the user with additional information regarding subject matter discussed in the video. After the website is opened, the user experience is guided by the website.

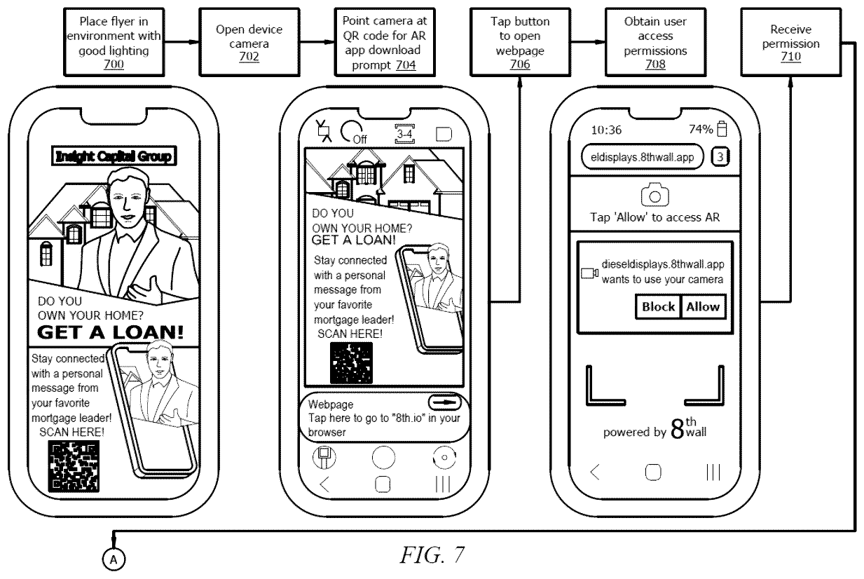

Referring to FIGS. 7-9, the augmented reality process flow is described in more detail. As shown in FIG. 7, the physical flyer (a 2-D object with at least one defined plane) is placed in the user's environment with sufficient lighting so that the images on the flyer can be perceived by the built-in camera of a mobile device (block 700). The device camera app is launched (block 702) and it is pointed at the image printed on the physical flyer so that the computer-readable code or QR code (or recognized marker embedded or incorporated in an image or pattern) is visible and perceived (block 704), which leads to the launch of a web browser and the display of a web page (block 706). Depending on the setting of the mobile device, the perception of the QR code may automatically lead to the web site. The user may then be prompted to allow the web site and mobile app to access the user's camera app (blocks 708 and 710).

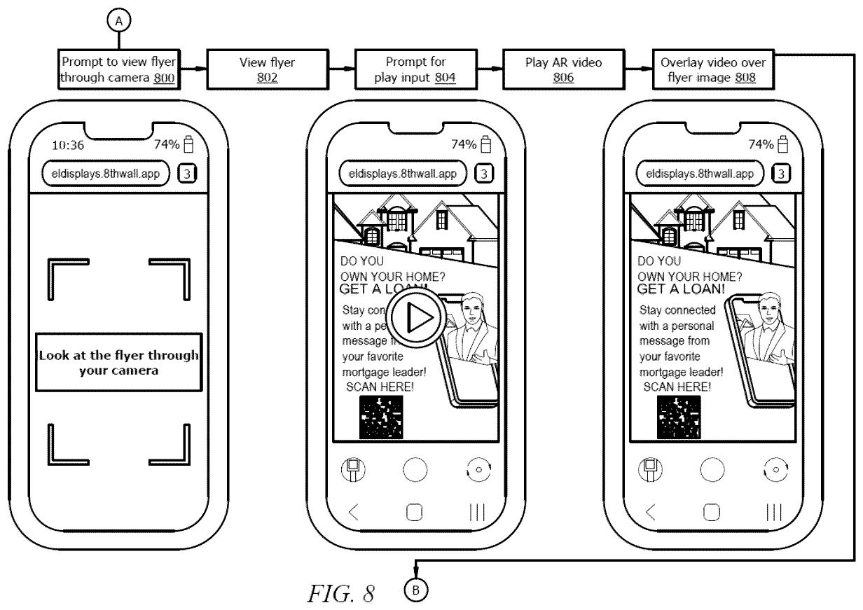

Referring to FIG. 8, the user is then prompted to point the device camera at the physical flyer and to view the physical flyer on the mobile device screen (blocks 800 and 802). The AR mobile app imposes the target image of the flyer onto the device screen in the same size and orientation as in the real-world environment. Optionally, a “play” button is displayed on the device screen and when the user taps the “play” button, it causes a video to be streamed from the website to the mobile device (blocks 804 and 806), and the image that is displayed on the screen becomes the video with moving images which may have audio components that are played via the mobile device speakers (block 808). Alternatively, the AR experience video automatically plays in place of the target image on the physical object as soon as the QR code (or recognized marker embedded or incorporated in an image or pattern) is detected by the mobile app. In such instances, the AR experience mobile app was already previously downloaded, installed, and ready for execution.

As shown in FIG. 9, the AR mobile app continually and dynamically analyzes and tracks the position, orientation, and perceived size of the physical flyer image as captured by the device camera, and superimposes the AR experience video onto the device screen as if the video images are being displayed on the actual paper flyer (block 900). The mobile app proceeds in this manner until the video ends, as detected in block 902. If the video has not ended, the mobile app also continually to detect whether the flyer has left the device camera image, i.e., whether the user has moved the mobile device so that the physical flyer is no longer in the field of view of the device camera (block 904). If the physical flyer is no longer within the field of view of the camera (the flyer is no longer part of the captured image of the device camera), the mobile app continues to show the AR video affixed on the device screen but preferably occupying the entire screen (block 906). The mobile app continues to monitor the captured image of the device camera to determine whether the flyer is now back in the field of view (block 908). If the flyer is now part of the captured image of the device camera, the mobile app may now superimpose the AR video back over the image of the flyer as before (block 900), until the mobile app detects that the video has ended (block 902). Once the video ends, an option is to allow the web browser to advance to a particular web page or web site where the user may peruse additional information related to the subject matter of the AR video. As described above, while the video is being displayed, the user may pause the video.

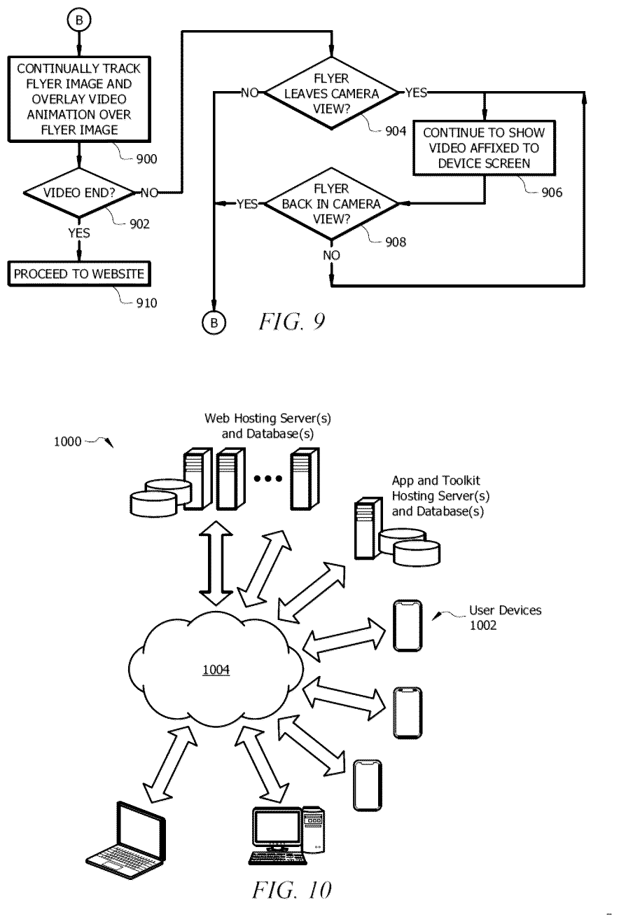

Referring to FIG. 10, the web pages of the web site, QR codes, AR images/videos, and target images are hosted on one or more web servers 1000, and the mobile app for user download may be hosted on the same or different servers, and may be hosted by third-party hosting services. Both sets of servers are accessible to the user's mobile device 1002 via WiFi, local area network, the cellular network, and/or other communication methods through the internet or global computer network 1004. The user devices 1002 may include any computing device that can be used or operated by a user, including mobile phones, laptops, notepad computers, desktop computers, wearable devices (e.g., glasses, headsets, heads-up displays, watches), and devices especially designed to enhance augmented reality (AR), mixed reality (MR), and virtual reality (VR) experiences.

It should be noted that the QR code (or recognized marker embedded or incorporated in an image or pattern) that is used to trigger the augmented reality session can be any form of computer-readable code or image/pattern that can be perceived by an imaging device on the user device. Further, the printed flyer is only one example of the physical carrier for the QR code. Any suitable 2-D or 3-D surface that may carry a static image can be used to initiate the AR experience. Other examples of the physical carrier may include business cards, playing cards, trading cards, newspaper ads, postcards, posters, signage, painting, drawing, billboards, flyers, product labels, product packaging, package inserts, user manuals, pet ID tags, personal identification cards, company badges, puzzle pieces, clothing tags, apparel, headwear, shoes, and jewelry.

The AR mobile app described herein may be implemented, maintained, and updated by using an AR app development toolkit described below. To facilitate ease of app development, maintenance and updates, the AR app development toolkit uses a repository of premade systems and devices, including templates, that can be readily deployed and tailored to create new AR mobile applications that results in greatly reduced development time. A variety of devices and input types are supported by the toolkit as the means to interact with premade and custom-made content. Two repositories are provided for the toolkit, one built in the Unity Engine, primarily using the C#programming language, and the other built primarily using JavaScript, HTML, and CSS for browser-based applications. The most notable difference in user-experience between applications built with these repositories is that apps created with the Unity version are to be installed on the user's device, while the browser version requires an internet connection in order to download the app to the user's device. The AR development toolkit also uses a Unity Engine extension called Mixed and Augmented Reality Studio (MARS), which adds new functionality to support augmented and mixed reality content creation. MARS provides a set of companion apps that provides the ability to address real-world objects.

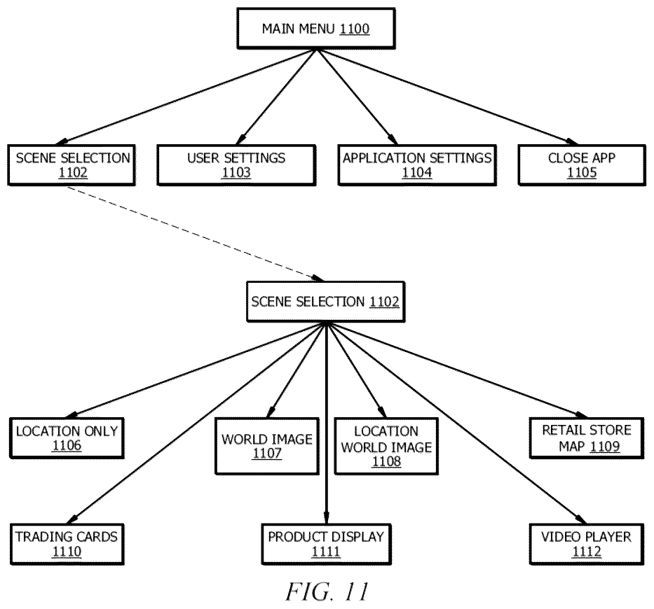

Hereinafter is a description of the AR development toolkit according to the teachings of the present disclosure. The term “developer” refers to the app developer who will be using the toolkit to develop AR mobile apps and the term “end user” refers to the user who will be using the AR mobile app. FIG. 11 shows an example architecture of the toolkit menu options. From a main menu 1100, the developer may selectively access a scene selection menu 1102, a user settings menu 1103, an application settings menu 1104, and a close app option 1105. In particular, from the scene selection menu 1102, the developer may select a number of schemes implemented in the toolkit in which to effect augmented reality or mixed reality scenes in the AR app, and these include: location only 1106, world-image 1107, location-world-image 1108, retail store map 1109, trading cards 1110, product display 1111, and video player 1112. More details of these AR schemes are described below.

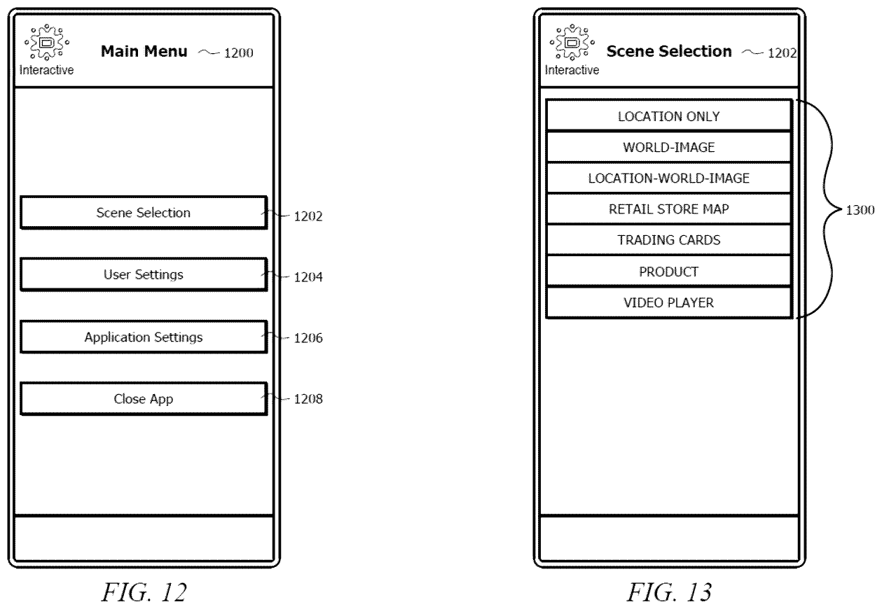

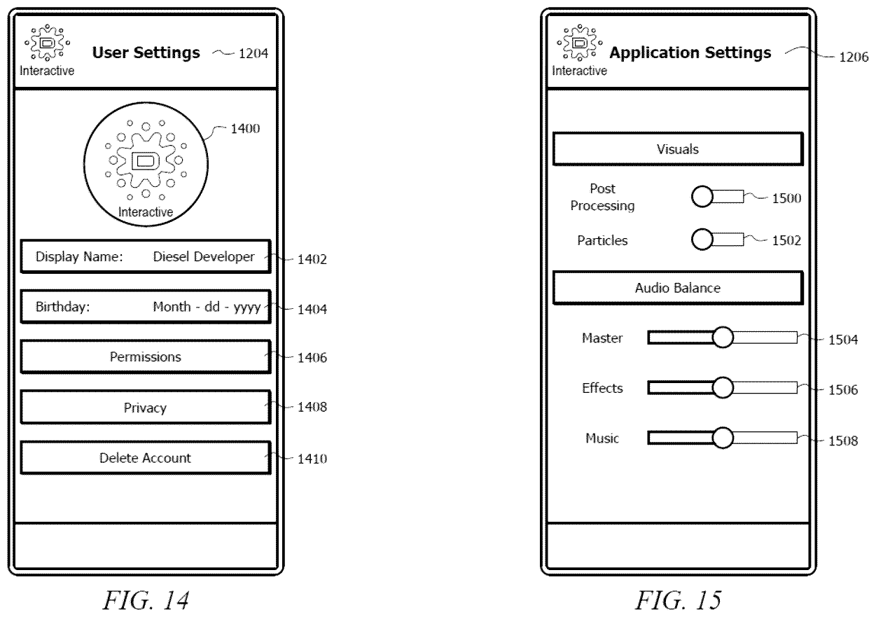

FIG. 12 shows an example of a Main Menu template 1200 provided by the toolkit. The Main Menu 1200 allows the developer to specify the first set of user interface elements to be displayed for viewing by an end user after the AR application finishes loading all necessary content. From the Main Menu 1200, the end user can click on various buttons 1202-1208 to open Scene Selection 1202 (FIG. 13), open their personal User Settings menu 1204 (FIG. 14), go to the Application Settings menu 1206 (FIG. 15), or close the mobile app 1208. Elements shared between FIGS. 12-15 include the project logo and the name of the displayed menu. The project logo can be changed by updating project settings visible to a developer. The name of the displayed menu is updated whenever a new menu is opened. All menus shown in the figures are templates which will be altered visually and, potentially, functionally when used to develop new AR applications.

FIG. 13 is the Scene Selection menu 1202 that lists the AR scenes 1300 that are available to be used in the AR app. Tapping a button will preserve any information or content necessary from the active scene such as digital content associated with the user, save user data such as their progress in the active scene, and open the corresponding scene. The available AR scenes include (FIG. 11): location only 1106, world-image 1107, location-world-image 1108, retail store map 1109, trading cards 1110, product display 1111, and video player 1112.

The location only scene 1106 is used in situations where given the GPS (global positioning system) location as an input data, and data associated with a detected or recognized plane in the real world image from MARS, an AR object may be placed on or affixed to the plane. The developer may upload or create a 2-D or 3-D AR object that is stored for the use by the AR app. The result of using the location only scene is the creation of an AR scene at a specified GPS location where an AR object appears to exist in the real-world scene. Therefore, the end user would see the AR object appear at the specified location having a relationship with a recognized plane such as affixed to a wall or placed on a tabletop.

The world-image scene 1107 enables the AR app to receive and recognize a real-world (3D) image by comparing it to an image stored in an image database, and overlay an AR object in the scene upon an image match. The result of using the world-image scene is the creation of an AR scene when there is a match between a real-world image and an AR object is placed in the scene so that it appears to exist in the real world.

The location-world-image scene 1108 enables the AR app to recognize a real-world image at a specified GPS location by comparing it to an image stored in an image database, and overlay an AR object in the scene upon an image match. The result of using the location-world-image scene is the creation of an AR scene when there is a match between a real-world image at a specified location, so that an AR object is placed so that it appears to exist in the real-world scene.

The retail store map scene 1109 enables the AR app to display a map of the layout of an indoor location, such as a retail store, and to indicate the location of the end user on the map and/or other guidance functions. The location of the end user (mobile device) may be provided by an indoor positioning utility using GPS, WiFi, Bluetooth or other positioning technologies.

The trading cards scene 1110 enables the AR app to receive and recognize a real-world trading card (e.g., a baseball card) by comparing its image to an image stored in a trading card image database, and overlay a video on the card upon an image match. Double-sided digital-2D objects are activated when a device camera detects the corresponding real-world card. Different behaviors can be associated with each side of the card. The result of using the trading card scene is the overlay of an AR experience video (animated images and audio) or static image when there is a match between a real-world trading card and a stored image. This AR scene utility may be used for recognition of other types of 2-D images such as the flyer example described above, billboards, posters, signage, etc.

The product display scene 1111 enables the AR app to receive a real-world image and recognize a plane on which to put or overlay the 3-D image of an AR object such as a product. The 3-D product images may be fetched from a separate product image database. As a result, the end user would see the 3-D image of a product positioned on or affixed to a surface so that it appears to exist in the real-world scene.

The video player scene 1112 enables the AR app to overlay a video player in the real-world scene. The result of using the video player scene allows the end user to see a video to be displayed along with the video controls (e.g., play, pause, stop) This AR scene utility may be used for overlaying a video player over any scene or object. This object can be attached to the user's device screen, placed at a location in real-world space, or attached to a video target image, allowing this single video player object to function as an inline video player akin to a YouTube video, or replicate a TV screen in a digital environment. The toolkits provides for adjusting pixel count and aspect ratio to match playing video. Green screen effect is available, and vents can be connected to timestamps in a video.

In any of the scenes in which video or animated images are overlayed or placed into the scene, a further control functionality may be available. For example, the toolkit may enable the detection of the end user's face and automatically pauses video play when it detects that the end user has turned away from the mobile device screen.

FIG. 14 is the User Settings menu 1204 provided by the toolkit that contains user data and security options. The profile picture 1400, display name 1402, and birthday 1404 may not be included or needed in AR applications without social interaction. Permissions 1406 refers to the device sensors and features the AR application is designed to use. The Permissions 1406 required by the AR application will vary. Privacy 1408 refers to the way in which user data is submitted for analytics and in applications with social features, what other users can see. Privacy settings will not be available in applications that do not make use of user data or include social features. The Delete Account setting 1410 will allow or prompt end users for confirmation that they wish to delete their account. The data deleted by this action, if selected by the end user, will vary between applications.

FIG. 15 is the Application Settings menu 1206 provided by the toolkit, which contains setting options for visual and audio effects in the AR application. Users can adjust these A/V settings to balance visual and audio quality and performance. Post Processing 1500, when enabled, applies effects to a users' camera view after elements in a scene are rendered for artistic improvements that may be at the cost of device performance. Post-processing may be disabled to improve performance. Particles 1502, when enabled, refers to small particulates used to simulate smoke, sparks, or dust. Hundreds of particles may be used at once to achieve the desired effect and thus, can affect the overall performance of the processor. The user may also adjust the frequency of on-screen animations updating, and set the amount of desired visual fidelity. Master volume 1504 adjusts all audio in the application. Effects 1506 adjusts the volume of sounds played as a response to an event in the application such as when a user taps a button or activates a particle system. Music 1508 adjusts the volume of any musical tracks used in the AR app including ambient tracks and music played in response to an event.

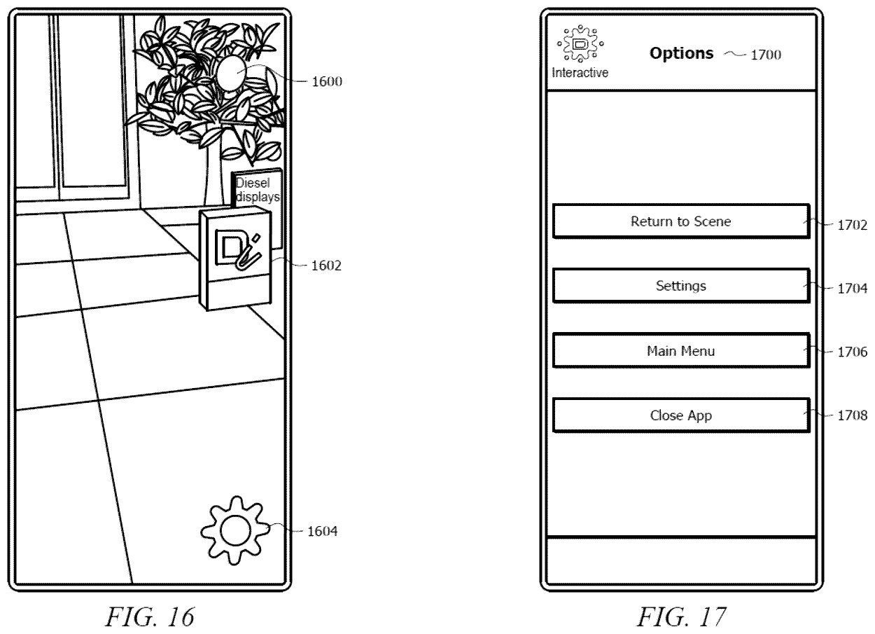

FIG. 16 is a screenshot of a marker-less augmented reality test scene example that positions an end user by way of the device GPS and compass. The camera view shows the real-world space the user is standing in. The compass visualization 1600 indicates the user's directional heading. When the red stripe on the compass points straight up toward the top of the screen, the user is facing North. The digital Diesel Interactive sign 1602 is placed in the digital world using real-world coordinates near the front door of Diesel Displays' building in Carrolton, Texas. When the user clicks on the scene options button 1604 opens a menu with options specific to the scene the user is in.

FIG. 17 is the Scene Options menu 1700. From this menu, users can return to the scene currently loaded 1702, open a settings menu specific to the scene currently loaded 1704, return to the main menu 1706, or close the app 1708. The Settings sub-menu 1704 will vary in appearance and functionality depending on the application and scene developed. FIG. 17 shows the menus and buttons available to the user while in a scene. Behaviors in the scene itself will vary between apps developed with the toolkit.

At each user interface panel, a back button or icon may be displayed to enable the user to navigate back to a previous user interface screen.

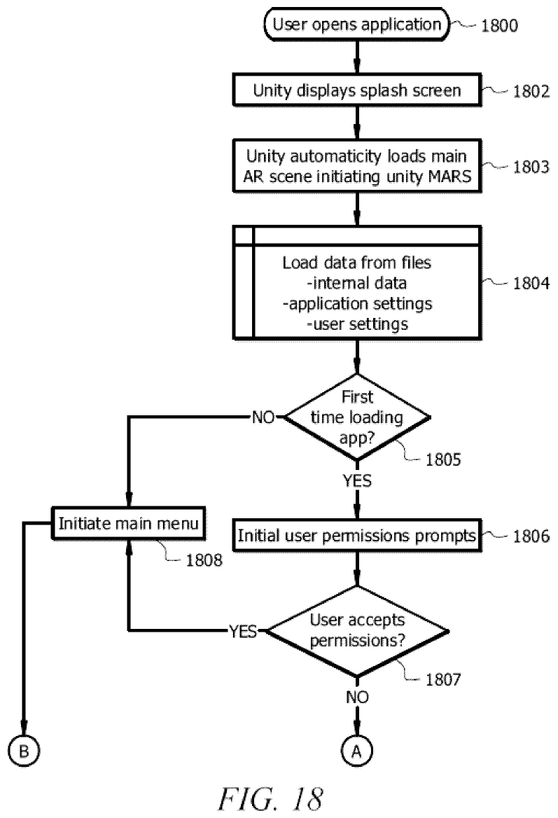

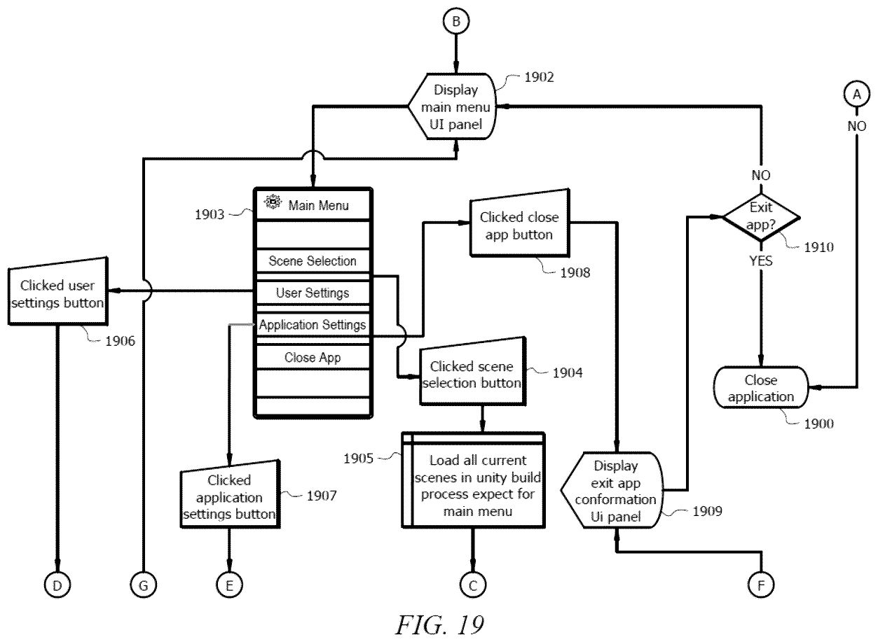

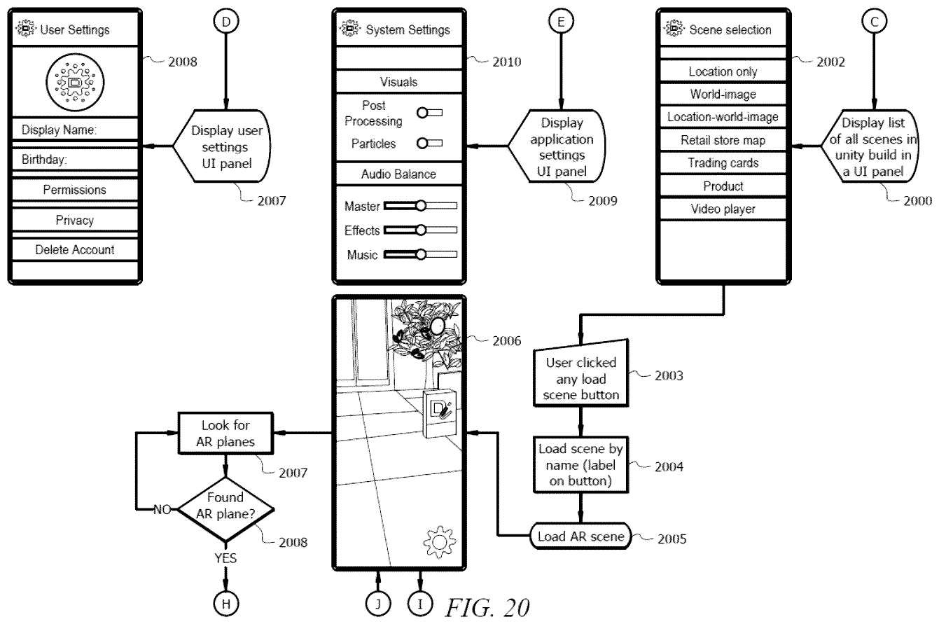

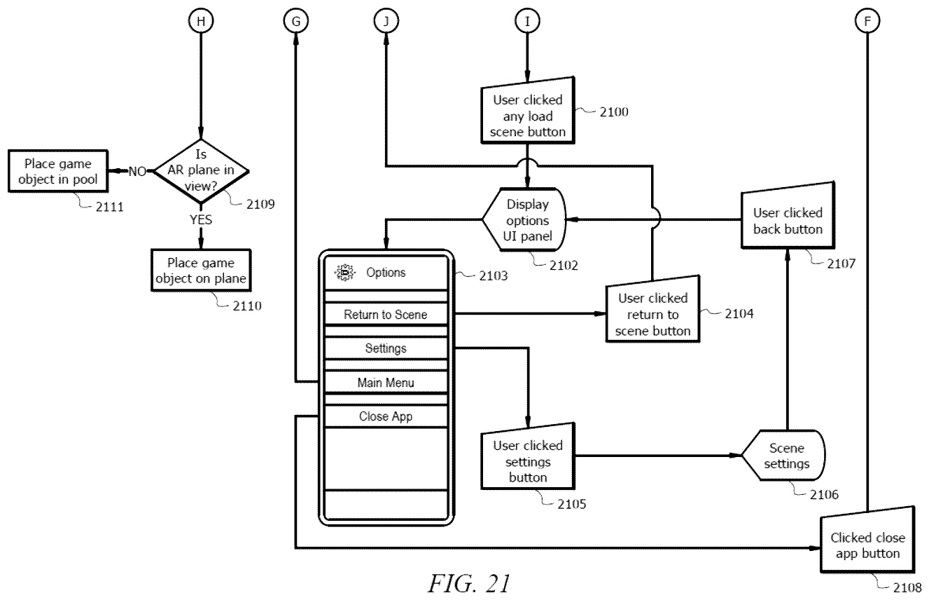

FIGS. 18-21 comprise a simplified flowchart showing how a developer accesses and navigates the toolkit to implement an AR application. User opens the application in block 1800, and the Unity Engine displays the splash screen (1802), and also automatically loads the main AR scene initiating MARS (1803). Further, internal data, application settings, and user settings are loaded from data storage or database into device memory for ready access (1804). If it is the first time that the application is being executed (1805), the user is prompted to give user permissions (1806). If the user does not give their permission for the application to access certain necessary data (1807), then the application execution is terminated (FIG. 19 block 1900). If it is not the first time the application is executed (1805), then the main menu is initiated (1808), and the main menu user interface panel (1903) is displayed (1902). From here, the user may selectively click on any button. If the user clicks on the scene selection button (1904), then all current scenes in the Unity Build process is loaded except for the main menu (1905). The list of all scenes in the Unity Build is displayed (2000) in the user interface panel (FIG. 20 block 2002). The available AR scenes include (FIG. 11): location only 1106, world-image 1107, location-world-image 1108, retail store map 1109, trading cards 1110, product display 1111, and video player 1112. From here, if the user clicks on any load scene button (2003), then the selected scene is loaded (2004 and 2005). An example AR scene is shown in block 2006. If the user clicks on any load scene button (2100), then the Options user interface panel (2103) is displayed (2102). If the user clicks on the return to scene button (2104) then the display returns to the AR scene (2006). If the user clicks on the Settings button (2105), then the scene settings are displayed (2106). If the user clicks on the back button (2107) then the user is returned to the Options user interface panel (2102). If at the Options screen (2103) the user clicks on the main menu button, then the screen display returns to the main menu (1902 and 1903). If the user selects the close app button at the Options user interface panel, then the application is shut down (2108).

Returning to the Main Menu user interface panel (1903), the second option is User Settings. If the user selects this option (1906), then the User Settings user interface panel is displayed (2007 and 2008), where the user may change the value of certain settings. The third option on the Main Menu (1903) is Application Settings. If the user selects this option (1907), then the Application Settings user interface panel is displayed (2009 and 2010), where the user may change the values of certain application settings. The fourth option on the Main Menu is Close App. If the user selects this option (1908), then a confirmation prompt is displayed (1909) and the application exits and closes (1910 and 1900).

Returning to the AR scene (2006), the MARS analyzes the real-world scene to detect AR planes (2007). Upon recognition of a plane (2008), and the AR plane is within the real-world image as viewed by the user, then the AR object or game object is placed or overlaid on the detected plane (2110). If at any time the MARS determines that the detected plane is no longer within view of the user (inside the real-world image), then the AR object is returned to the pool (device memory) to remain readily accessible (2111).

In the user experience example described herein, a user may use AR mobile apps built for a mobile device's operating system or a web browser to initiate and enjoy the AR experience. Both examples are initialized by using a device camera to scan a QR code or target image(s). When users open the website prompted by the QR code, two flow paths can follow depending on whether the user is using a browser-based app or a downloaded app. If the app is browser-based, the app will open in the user's browser. If the app is downloadable, users will be prompted to download, install, and open the app. Once the app is open in a browser or on the device, the app will enter its startup sequence, then its main loop. The users may be prompted to provide the necessary permissions for the app to access device sensors and functionality. Via the Main Menu, the user has access to settings for their own profile within the app and settings that control features about the app itself. Both of these user interface panels have different designs between apps depending on features necessary for that app. A button to close the application is present, which prompts the user to confirm their decision before closing the application.

The toolkit also provides for the background process responsible for updating the applications. The update process is a co-routine that starts running after the app finishes loading and continues to run until it is ended by another app function. This process is invisible to the user unless a user permission is needed, or a restart of the application is necessary. Content that is hosted externally on web servers, such as images or audio/video files can be updated without affecting the running application. Updates to the applications code, scenes, or assets built into an application require the app be closed and updated via the Apple App Store or Google Play store.

It should be noted that the QR code or AR marker employed herein can be any form of computer-readable or detectable code or pattern that can be perceived by the computing device. It can even be, for example, one or more sounds (detectable or not detectable by humans) that can be “heard” or sensed by the computing device's microphone as an audio input. Instead of a machine-readable pattern like a QR code or bar code, the sophisticated mobile app may analyze the captured image for recognition of any pre-existing stored image or pattern, that can be a pattern perceivable by the imaging device of the user device in any range of the electromagnetic spectrum.

It is contemplated that an application system includes support for multiple input types; touch(es); swipe/gesture detection; mouse, keyboard input; gamepad support; VR Gaze controls; VR Controller Support; GPS Position; compass Orientation; and device acceleration. The toolkit provides adaptive user interface panels that change displayed menu content to reflect available user inputs. In the case of VR input, users can make use of the ability to move menus between screen space where menus are suffixed to the user's vision and world space where menus sit at a point in 3D digital space the user can interact with using the position of their VR controllers or the location they are looking (gaze controls).

It should be contemplated that the adaptive user interface with support for multiple input types and alternative menu layouts for different input types. Menus can occupy a location in a 3-D rendered scene or be affixed to the screen-space of a device. Some user interface elements, such as the video player, will support both. Objects can transition between world-space and screen-space if this feature is supported for said object.

It is contemplated herein that AR recognition from QR code (or recognized marker embedded or incorporated in an image or pattern) includes functional and working through a web-browser; a QR code can prompt users to open a website hosting a browser-based AR app; and opening the app is a multi-step process, requiring individual user permission prompts due to allowances/limitations on various Operation Systems. Constantly working on this function to verify whether it can be over-come in the future.

It is contemplated herein that the toolkit enables the development of downloadable applications where a QR code (or recognized marker embedded or incorporated in an image or pattern) can prompt users to open a website hosting a downloadable app installation file; the user is prompted to download and install the app; the user is prompted to give permission for device sensors and functions when the app runs on their device. Because the app is installed on their device, the user only has to grant permission once.

It is contemplated herein that users are able to unlock additional AR content by scanning QR codes using their device camera app and/or using the AR camera within an AR app.

It is contemplated herein that the toolkit provides a display animation control script that can be attached to any animated 3-D model, allowing that model to react to a variety of stimuli including user input, collision with digital objects, device movement, or any other stimuli detectable by the application. Further, a 3-D animation sequence may be combined with a video sequence. For example, when the user's device camera looks at a postcard, an animated digital 3-D model of that postcard is seamlessly placed on top of the real postcard. The card appears to open (3-D animation), and a digital video slides out of the opening and begins to play.

It is contemplated herein that the toolkit provides a scene management system for changing between Unity scenes. Efforts are taken to minimize the number of scene changes during runtime. When scene changes are required, the Scene Management disconnects persistent objects from scene objects in the current scene, unloads the current scene, then loads the new scene.

It is contemplated herein that the AR development toolkit provides a content management and update system. Updates to some content within the app can be downloaded during runtime without requiring the user to close, update, and reopen the app. Users can delay or opt out of updates to some content. For example, visual updates or updates that may conflict with what they are doing during their current session. Feature updates that alter the app's programming will require closing and updating the app. Applications should cache data on user devices to improve load times and allow users to access apps when offline.

It is contemplated herein that the toolkit provides a video player with the following functionalities: transition between world-space and screen-space; pause/play functionality; adjust pixel count and aspect ratio to match playing video; green screen effect. Further, events can be connected to timestamps in a video. For example, a video displayed in world-space could be complemented by a water splash effect that appears in 3-D when an object hits water in the video.

It is contemplated herein that the toolkit provides an animation system that supports 3-D animation. Artistic 3-D animations and character animations are possible in both web AR and Unity AR. A script will handle animation transitions for animated sequences and characters which are reliant on user input.

It is contemplated herein that the toolkit provides a network multi-user environment that enables support for cross-platform multiplayer for local and server-based connections. This functionality may use, for example, Bluetooth and WiFi, for local connections. Server communication is used for users not sharing a local space.

It is contemplated herein that the toolkit provides AR features that include: ability to track multiple images and 3-D objects in AR; ability to identify and track items placed by different users in AR (may require users to press button or scan the object they are about to set down, then ping other devices to identify and track said item but recognize another user's ownership of item); ability to see other users in AR. Uses a mix of GPS coordinates and devices sharing their world tracking and image tracking data; and system for target images with definitions of real space coordinates that can be used to re-orient the application and place users at more accurate GPS coordinates.

It is contemplated herein that the toolkit provides an image scanner (achieved with, for example, Vuforia) so that users can interact with real-world graphics by viewing them through their camera with an AR app open. Images recognized by the application will prompt a reaction from the application. The toolkit uses, for example, MARS to provide image recognition for determining the type of content displayed to users and use of tracked images as anchors for displaying content with greater stability than just world-tracking.

It is contemplated herein that the toolkit provides a world scanning tracking functionality (achieved with, for example, Vuforia). The device camera detects visual contrast in the environment. As the user moves the device, it is able to triangulate its position based on the time required for points of reference to move within the camera's field of vision. This allows the device to calculate precise movements in a digital AR scene. World scanning allows digital 3-D objects placed in the environment to interact with the real world to a limited degree.

It is contemplated herein that the toolkit provides application mod tools including digital world layout configuration that includes a tool accessible to developers and clients allowing them to place digital objects at real-world GPS coordinates, or connect digital objects to trackable images and trackable real-world spaces. The configuration files can be edited and loaded by the application to alter its behavior.

It is contemplated that to create an augmented reality system capable of transitioning between indoor and outdoor environments, the device camera, GPS, Compass, Accelerometer, and Gyroscope are used simultaneously to obtain an accurate real-world position and direction. With the combined tracking data, digital content can exist at real-world locations defined by developers or users. With the combined tracking data, users can move through the real and digital world similarly to how they would move through a virtual environment in a video game. The AR system supports tracking for multiple items simultaneously. Ability to identify and track items placed by different users in AR. May require users to press button or scan the object they are about to set down, then ping other devices to identify and track said item but recognize another user's ownership of item. Ability to see other users in AR may be provided, and function with a mix of GPS coordinates and devices sharing their point clouds. System for target images with definitions of real space coordinates that can be used to re-orient the application.

It is contemplated herein that the toolkit provides the following features available to users: limited behavior changes and configurable settings through in-app user interfaces.

In summary, the toolkit provides the ability to evoke an augmented reality experience for the end user that may be implemented by using a QR code (or another machine-detectable code such as a marker embedded in an image) for the following applications: business cards, flyers, game cards, drawings, paintings, greeting cards, window displays, player cards (all professional and amateur sport teams), trading cards, playing cards (for stats, game play, tutorials, etc.), souvenirs, food packaging, beverage packaging, toy packaging, books, gaming boards, retail packaging, wallpaper, event and performance tickets, performance programs, signage (e.g., real estate signage, building signage), puzzle pieces, apparel design, shoe design, and headwear design. The applications may be for augmented reality experiences for zoos, aquariums, amusements parks and rides, ball parks, stadiums, city, state, and national parks (to provide guidance, map, talk with virtual park rangers, etc.), car dealerships (interior, exterior, and engineering of cars), auto auctions (interior, exterior, and engineering of cars), museums, art galleries, apparel, shoes & accessories, (retail and wholesale), real-estate brokers/agents (for virtual tour of property), architectural firms (for virtual tour of property), interior design firms, real estate neighborhood developers (for virtual tour of neighborhood), and event organizers (to experience how events can look and feel).

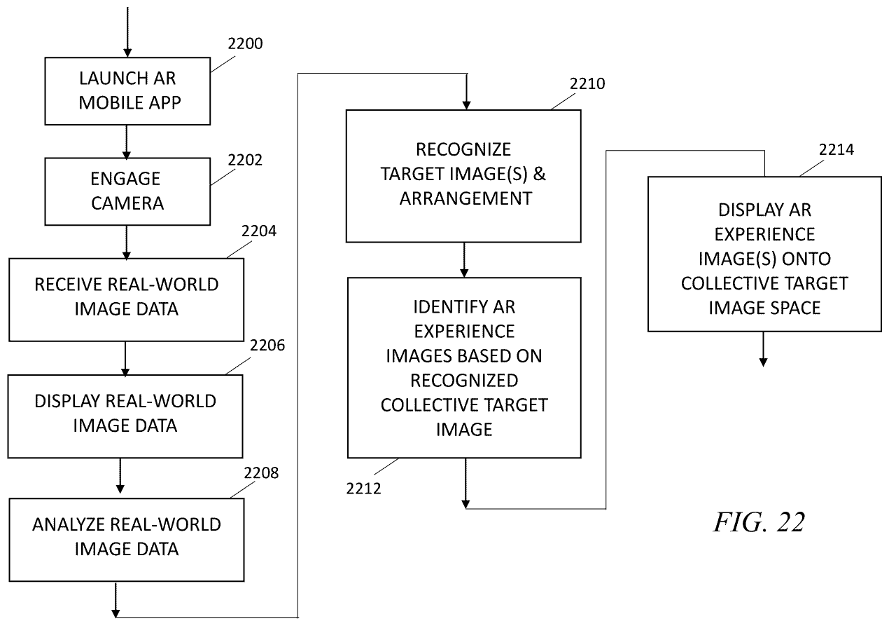

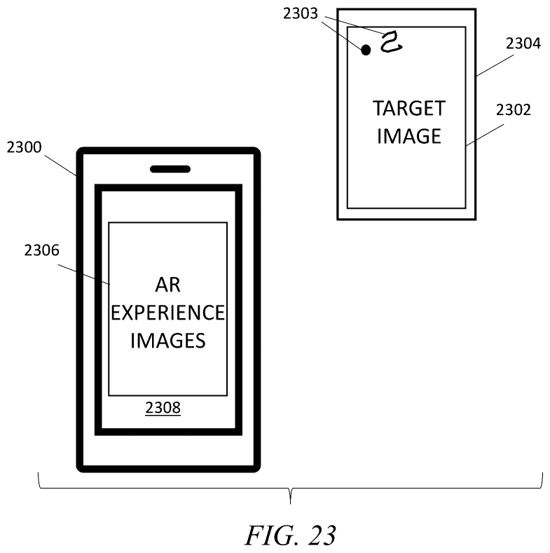

Turning now to FIGS. 22-33, further embodiments of the AR mobile app inventive concepts are shown. FIG. 22 is a simplified flowchart illustrating a method of enabling an AR mobile app executing on a mobile device 2300 (FIG. 23) to overlay an AR video or animated images onto the real-world target image that is displayed on the screen of the mobile device. Referring to FIG. 22, the user of the mobile device 2300 launches the AR mobile app that executes on the mobile device, as shown in block 2200. For example, the user clicks on the icon of the AR mobile app that is displayed on the screen of the mobile device to launch the AR mobile app. As part of the functionalities of the mobile app, the operation of the camera (or imaging) device that is coupled to or resident in the mobile device is automatically enabled and engaged, as shown in block 2202. Using the camera device, the mobile device screen displays an image of the real-world scene that is perceived and captured by the camera device, as shown in block 2206. The processor (CPU) of the mobile device 2300 also receives the real-world image data perceived and processed by the camera device and software and analyzes the real-world image data, as shown in block 2208. The processor makes a comparison of the received real-world image data with stored target image data to determine if the real-world image data contain or incorporate at least a portion of an AR experience target image. The image analysis process may “look” for one or more “markers” that have been previously isolated and identified in the target image. These markers are/include unique patterns that exist or have been added to the target image that allow the AR mobile app to recognize the presence of the target image in the perceived image data. The detection of the markers triggers the AR experience for the user and involves the display/presentation of AR experience images (e.g., video, audio, animation) on the mobile device screen. The specific AR experience displayed or provided to the user depends on the detection of the unique set of one or more markers present in the perceived target image. The markers and AR experience videos (and the target images and markers) are stored in a cloud-based database accessible to the mobile app via wireless communication channels.

FIG. 23 illustrates this concept, where the mobile app executing on the mobile device 2300 and using the resident camera device and software, captures and analyzes the real-world image data to determine if it includes or contains the markers 2303 in the target image 2302. The real-world object 2304 functioning as a physical carrier that contains or incorporates the target image 2302 and markers 2303 may be any 2-D or 3-D object, such as business cards, playing cards, trading cards, newspaper ads, postcards, posters, signage, painting, drawing, billboards, flyers, product labels, product packaging, package inserts, user manuals, pet ID tags, personal identification cards, company badges, puzzle pieces, clothing tags, apparel, headwear, shoe, and jewelry. Upon recognition of the target image 2302 (because of the presence of the unique markers 2303) being at least a part of the real-world scene being captured by the camera device, one or more stored AR experience images (e.g., video only or video with audio) 2306 are identified and displayed on the display screen 2308 of the mobile device 2300 for viewing by the user, as shown in blocks 2212 and 2214 (FIG. 22). The AR experience images 2306 are displayed on the mobile device screen 2308 such that they are shown to the user as if they occupy the space of the target image 2302 and seemingly replace the target image 2302 on the physical carrier 2304. As a result, the user, looking at the mobile device screen 2308, appears to see the AR experience images 2306 imposed on the physical carrier 2304 instead of the target image 2302. By viewing the screen 2308 of the mobile device 2300, the user sees that the subject matter originally depicted in the target image 2302 appears to come alive. For example, the target image 2302 may be that of a certain professional baseball player on a baseball card. By using the AR mobile app, the user sees the same baseball player come to life and makes a swing and hits a homerun. In an alternate embodiment, when the user views the mobile device screen 2308, the AR experience images 2308 may appear to extend beyond the boundaries of the original target image 2302 in one or more directions to further enhance the immersive AR experience. In this way, the AR experience images may appear to extend beyond the 2-D surface of the target image and become 3-D.

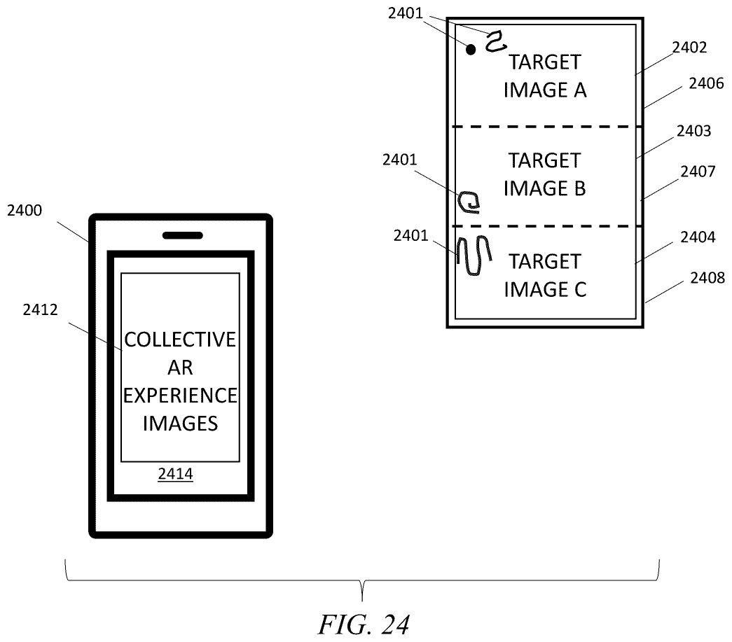

The AR mobile app is configured to recognize any single target image of any shape and orientation (due to the recognition of one or more unique markers incorporated in the target image). In addition, the AR mobile app is configured to recognize a combined image of multiple target images arranged in a recognized configuration (due to the recognition of the combined set of markers incorporated in the target images). As shown in FIG. 24, the mobile app executing on the mobile device 2400, using the camera device and software onboard the mobile device, captures and analyzes the real-world image data to determine if it includes or contains markers 2401 in the target images 2402-2404 combined together in an arrangement and orientation recognized by the mobile app. The real-world objects 2406-2408 that function as physical carriers that respectively contains or incorporates the target images 2402-2404 may be any 2-D or 3-D object, such as business cards, playing cards, trading cards, newspaper ads, postcards, posters, signage, billboards, product labels, product packaging, package inserts, user manuals, pet ID tags, personal IDs, company badges, puzzle pieces, clothing tags, apparel, shoes, headwear, and jewelry. Upon recognition of the target images being at least a part of the real-world scene currently captured by the camera device, one or more stored AR experience images (e.g., video only or video with audio) 2412 are identified and presented on the display screen 2414 of the mobile device 2400 for viewing by the user. The AR experience images 2412 are displayed on the mobile device screen 2414 such that they are shown to the user as if they occupy the space of the target images 2402-2404 and seemingly replace the target images 2402-2404 on the physical carriers 2406-2408. As a result, the user, looking at the mobile device screen 2414, appears to see the AR experience images 2412 imposed on the physical carriers 2406-2408 instead of the target image 2402-2404. The user's experience is that, by viewing through the screen 2414 of the mobile device 2400, the subject matter depicted in the target images 2402-2404 appears to come alive.

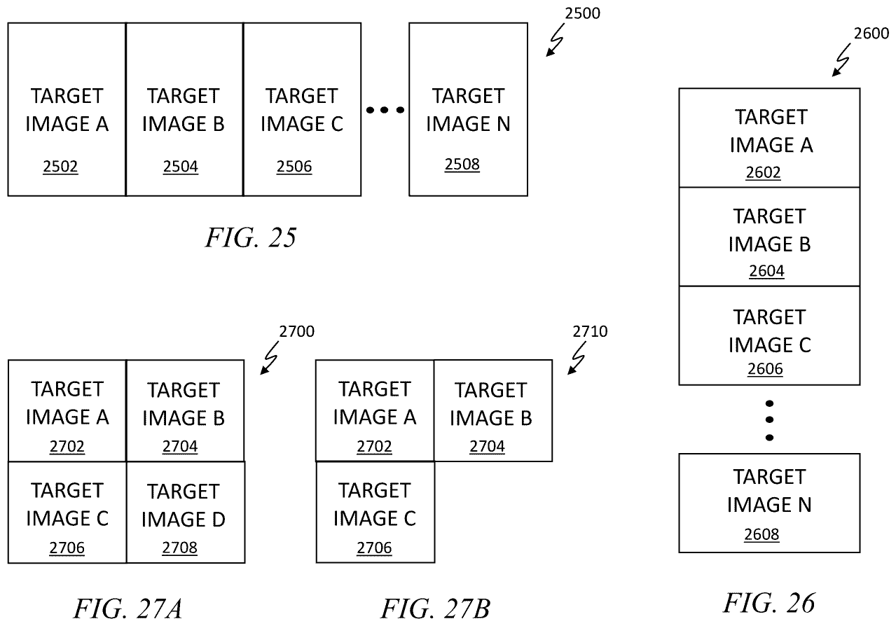

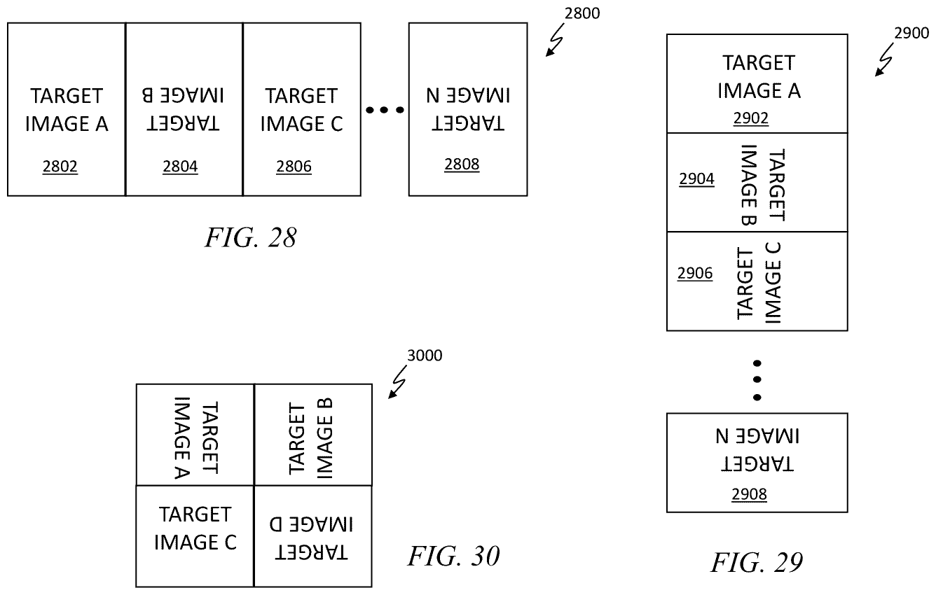

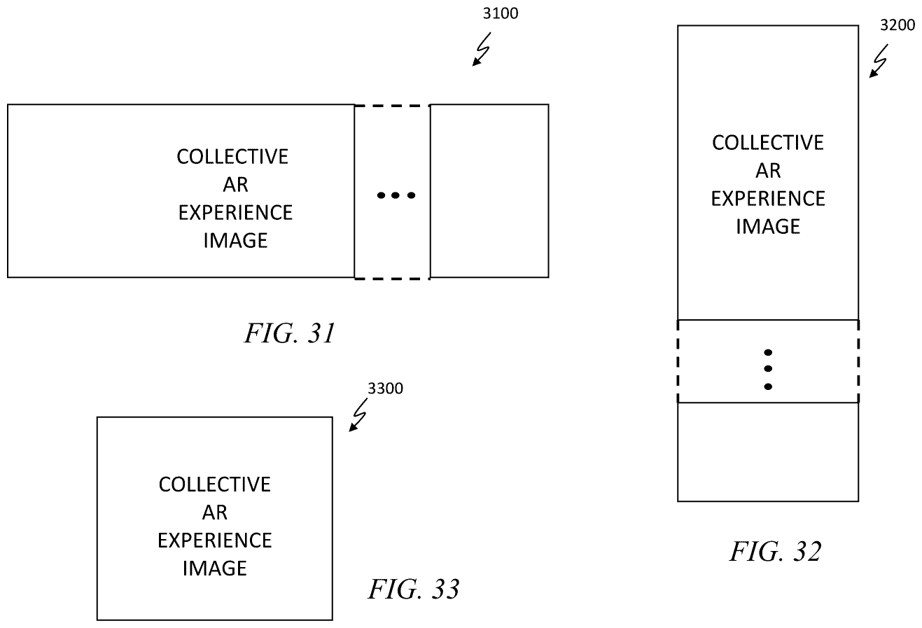

The AR mobile app is configured to recognize any single target image of any shape and orientation (due to the recognition of one or more unique markers incorporated in the target image). In addition, the AR mobile app is configured to recognize a combined image of multiple target images arranged in a recognized configuration (also due to the recognition of the combined sets of markers incorporated in the target images), three examples of which are shown in FIGS. 25-27A and 27B. In FIG. 25, the example target images 2502-2508 are arranged or oriented horizontally, with the resultant AR experience image 3100 shown in FIG. 31. The AR experience image 3100 may be one set of AR images or multiple sets of AR images superimposed on top of one another to create a unique AR experience. In FIG. 26, the example target images 2602-2608 are arranged or stacked vertically, with the resultant AR experience image 3200 shown in FIG. 32. The AR experience image 3200 may be one set of AR images or multiple sets of AR images superimposed on top of one another to create a unique AR experience. In FIG. 27A, the example target images 2702-2708 are arranged or stacked in a grid pattern, with the resultant AR experience image 3300 shown in FIG. 33. The AR experience image 3300 may be one set of AR images or multiple sets of AR images superimposed on top of one another to create a unique AR experience. The shape and number of stacked target images is not limited. Further, as shown in FIGS. 28-30, the individual orientation of the target images may also be varied to elicit further specific AR experience images. For example, the arrangement of target images A-C in FIG. 30 in different orientations to create the combined images 3000 may trigger different AR experience images than the combined images 2700 shown in FIG. 27A using the same target images A-C. As shown in FIG. 27B, the physical carriers may be assembled to create an irregularly-shaped image space 2710 to allow an overlay of AR experience videos and/or images over that space on the display screen.

FIGS. 28-30 illustrate that the manner in which the physical carriers are assembled and oriented may initiate different unique AR experiences. For example, the collection 2800 of target images 2802-2808, with specific ones in an inverted orientation, may result in an AR experience that is different from one that is triggered by the same images all oriented in the same direction. Similarly, the collection 2900 of target images 2902-2908, with the target images placed in different orientations, may result in an AR experience that is different from one that is triggered by the same images all oriented in the same direction. The same holds true for the grid collection 3000 of target images A-D shown in FIG. 30 where the orientation of specific images may result in a different AR experience. Therefore, the number of unique AR experiences initiated by the presence of specific target images and the configuration and orientation of how they are placed, can be countless. Imagine the presence of two trading cards bearing the still images of two professional wrestlers being positioned together in a specific way that would trigger an AR experience showing the user a ring-side video of a specific wrestling match/wrestling move/interaction between these two wrestlers.

It should be noted that the mobile app may overlay the AR experience images onto the space taken up by the target images on the display screen. However, the mobile app may display the AR experience images that extend in one or more directions beyond the original target image space when viewed on the screen. In particular, as viewed by the user on the mobile device screen, the collective AR experience images may be a 3-D video that appear to project out of the 2-D target image space disposed on the physical carriers.

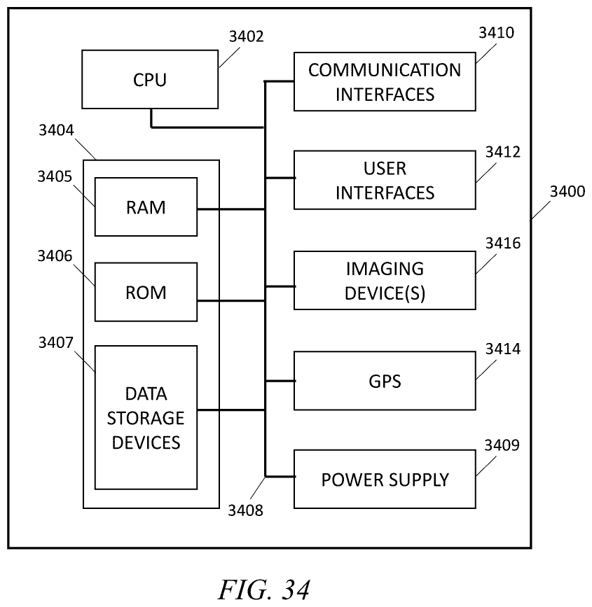

FIG. 34 is a simplified block diagram of an example of a mobile device 3400 that may be used as the executing platform for the AR mobile app described herein. The mobile device 3400 includes a processing unit (CPU) 3402 in communication with a memory device 3404 (including, for example, RAM 3405, ROM 3406, and other data storage devices 3407) via a data bus 3408. The mobile device 3400 also includes a power supply (e.g., battery and interface to an external power source) 3409, one or more communication interfaces (e.g., cellular, Bluetooth, WiFi, Near Field Communications, USB) 3410, RF circuitry, and a whole suite of user interface devices 3412 (e.g., speaker, microphone, audio input jack, touch screen, keypad, and haptic feedback device), global positioning systems (GPS) circuitry 3414, front and rear facing camera(s) (including imaging sensors, image signal processor or ISP, lenses, autofocus mechanism, flash, image stabilization, etc.), and/or other optical, thermal or electromagnetic sensors 3416 (for detecting markers in a range of the electromagnetic spectrum outside of the visible range). It should be noted that the mobile device 3400 may be a mobile telephone, notepad computer, laptop computer, wearable device (e.g., glasses, heads-up display) and any other appropriate computing platform suitable for the execution of the AR mobile app described herein.

The features of the present invention which are believed to be novel are set forth below with particularity in the appended claims. However, modifications, variations, and changes to the exemplary embodiments described above will be apparent to those skilled in the art, and the AR mobile app and the AR app development toolkit described herein thus encompasses such modifications, variations, and changes and are not limited to the specific embodiments described herein.

What is claimed is:

1. An augmented reality (AR) method using a mobile device having a display screen capable of displaying images captured by an imaging device, the method comprising:
receiving an image of at least one real-world object from the imaging device, the image of the at least one real-world object including image data of at least one target image incorporating at least one marker and disposed on the real-world object;
automatically detecting a presence of the at least one marker in the image data of the at least one target image;
automatically identifying at least one AR experience video in response to the detected at least one marker;
automatically accessing a database to retrieve the at least one AR experience video; and
automatically receiving the at least one AR experience video and automatically rendering the at least one AR experience video on the display screen of the mobile device for viewing by a user, the at least one AR experience video replacing at least a portion of the at least one target image on the real-world object when viewed on the display screen.

2. The AR method of claim 1, wherein automatically detecting a presence of the at least one marker in the image data of the at least one target image comprises automatically detecting a certain set of a plurality of markers present in a plurality of specific target images arranged and oriented in a certain predetermined manner.

3. The AR method of claim 1, wherein automatically detecting a presence of the at least one marker in the image data of the at least one target image comprises automatically detecting a certain set of a plurality of markers present in a plurality of specific target images arranged in a certain predetermined manner including orientation of each of the plurality of target images.

4. The AR method of claim 1, wherein automatically rendering the at least one AR experience video comprises automatically rendering a plurality of AR experience videos on the display screen arranged in arranged in a certain predetermined manner relative to the position and orientation of the at least one target image.

5. The AR method of claim 1, wherein automatically rendering the at least one AR experience video comprises automatically rendering the at least one AR experience video on the display screen extending beyond space previously occupied by the at least one targe image on the real-world object in at least one direction.

6. The AR method of claim 1, wherein automatically rendering the at least one AR experience video comprises automatically rendering the at least one AR experience video on the display screen extending beyond space previously occupied by the at least one targe image on the real-world object so that the user perceives an immersive 3-D AR experience.

7. The AR method of claim 1, further comprising:
isolating and storing at least one marker associated with at least one target image in the database; and
storing at least one AR experience video in the database with association to at least one of the at least one target image and at least one marker.

8. The AR method of claim 1, wherein receiving an image of a real-world object incorporating the at least one marker comprises receiving an image of an object selected from the group consisting of business cards, playing cards, trading cards, newspaper ads, postcards, posters, signage, painting, drawing, billboards, flyers, product labels, product packaging, package inserts, user manuals, pet ID tags, personal identification cards, company badges, puzzle pieces, clothing tags, apparel, headwear, shoes, and jewelry.

9. The AR method of claim 1, wherein automatically rendering the AR experience video on the display screen of the mobile device comprises automatically tracking the position and orientation of the real-world object as rendered on the display screen and maintaining the AR experience video superimposed over the at least one target image on the real-world object.

10. A mobile app configured for execution on a user device to implement augmented reality (AR), the user device having a display screen and a camera, the mobile app configured to:
receive an image of at least one real-world object from the imaging device, the image of the at least one real-world object including image data of at least one target image incorporating at least one marker and disposed on the real-world object;
automatically detect a presence of the at least one marker in the image data of the at least one target image;
automatically identify at least one AR experience video in response to the detected at least one marker;
automatically receive the at least one AR experience video and automatically render the at least one AR experience video on the display screen of the mobile device for viewing by a user, the at least one AR experience video replacing at least a portion of the at least one target image on the real-world object when viewed on the display screen.

11. The mobile app of claim 10, configured to automatically detect a certain set of a plurality of markers present in a plurality of specific target images arranged in a certain predetermined manner.

12. The mobile app of claim 10, configured to automatically detect a certain set of a plurality of markers present in a plurality of specific target images arranged in a certain predetermined manner including orientation of each of the plurality of target images.

13. The mobile app of claim 10, configured to automatically render a plurality of AR experience videos on the display screen arranged in a certain predetermined manner relative to the position and orientation of the at least one target image.

14. The mobile app of claim 10, configured to automatically render the at least one AR experience video on the display screen extending beyond space previously occupied by the at least one targe image on the real-world object in at least one direction.

15. The mobile app of claim 10, configured to automatically render the at least one AR experience video on the display screen extending beyond space previously occupied by the at least one targe image on the real-world object so that the user perceives an immersive 3-D AR experience.

16. The mobile app of claim 10, further configured to:
isolate and store at least one marker associated with at least one target image in the database; and
store at least one AR experience video in the database with association to at least one of the at least one target image and at least one marker.

17. The mobile app of claim 10, configured to receive an image of a real-world object selected from the group consisting of business cards, playing cards, trading cards, newspaper ads, postcards, posters, signage, painting, drawing, billboards, flyers, product labels, product packaging, package inserts, user manuals, pet ID tags, personal identification cards, company badges, puzzle pieces, clothing tags, apparel, headwear, shoes, and jewelry.

18. The mobile app of claim 10, configured to automatically track the position and orientation of the real-world object as rendered on the display screen and maintaining the AR experience video superimposed over the at least one target image on the real-world object.

19. A non-transitory computer-readable medium containing electronically encoded method for execution by a computer to perform an augmented reality (AR) method using a mobile device having a display screen capable of displaying images captured by an imaging device, the AR method comprising:
receiving an image of at least one real-world object from the imaging device, the image of the at least one real-world object including image data of at least one target image incorporating at least one marker and disposed on the real-world object;
automatically detecting a presence of the at least one marker in the image data of the at least one target image;
automatically identifying at least one AR experience video in response to the detected at least one marker;
automatically accessing a database to retrieve the at least one AR experience video; and
automatically receiving the at least one AR experience video and automatically rendering the at least one AR experience video on the display screen of the mobile device for viewing by a user, the at least one AR experience video replacing the at least one target image on the real-world object when viewed on the display screen.

20. The non-transitory computer-readable medium of claim 19, wherein the AR method automatically detects a certain set of a plurality of markers present in a plurality of specific target images arranged and oriented in a certain predetermined manner.
